(19) United States
(12) Patent Application Publication
(10) Pub. No.: US 2020/0332555 A1
(43) Pub. Date: Oct. 22, 2020

(54) LOCKING DEVICE FOR FLAPS ON AIRCRAFT

(71) Applicant: Lufthansa Technik AG, Hamburg (DE)

(72) Inventors: Wolfgang Sutter, Halstenbek (DE); Martin Olesch, Hamburg (DE)

(21) Appl. No.: 16/772,832

(22) PCT Filed: Dec. 19, 2018
(86) PCT No.: PCT/EP2018/085757

§ 371 Date: Jun. 15, 2020

(30) Foreign Application Priority Data
Dec. 22, 2017 (DE) 10 2017 223 684.1

(51) Int. Cl. E05B 17/10; E05C 19/14; E05B 41/00; B64D 29/06

(52) U.S. Cl. CPC E05B 17/106; B64D 29/06; E05B 41/00; E05C 19/145

(57) ABSTRACT

A locking device can be embedded flush into a surface and is intended for locking flaps of an aircraft. The locking device includes a plate and a locking element, which is actuatable thereby. In a locked state of the locking device, the plate is flush with the surface and, in an open state, the plate projects from the surface. At least some faces of the locking device, which are situated on an inside with respect to the surface in the locked state and are visible only in the open state, are coated with photoluminescent material.

### CROSS-REFERENCE TO PRIOR APPLICATIONS

This application is a U.S. National Phase Application under 35 U.S.C. § 371 of International Application No. PCT/EP2018/085757, filed on Dec. 19, 2018, and claims benefit to German Patent Application No. DE 10 2017 223 684.1, filed on Dec. 22, 2017. The International Application was published in German on Jun. 27, 2019 as WO 2019/121863 A1 under PCT Article 21(2).

### FIELD

The invention relates to a locking device which can be embedded flush into a surface and is intended for locking flaps or the like, in particular for aircraft.

### BACKGROUND

Aircraft often have a large number of openings on the outer surfaces, allowing access for maintenance personnel to systems situated underneath for the purpose of servicing, inspection or repair. Maintenance openings for access points that have to be opened only infrequently are often closed by means of screwed covers, to open which the screws have in each case to be completely undone. For maintenance openings that have to be opened more frequently, use is made in many cases of flaps or doors that are attached by means of a hinge or pivoting mechanism and have locking devices, which can be opened and closed without using tools.

Corresponding locking devices of the kind shown in U.S. Pat. Nos. 4,531,769 and 5,620,212 can have a plate and a locking hook, which are connected via a mechanism in such a way that, after engaging in a mating part, the locking hook is tightened by actuating the plate in order to achieve secure locking. In general, such locking devices are integrated movably or pivotably into the flap or door, while the required mating part or abutment is mounted to receive the locking hook in the fixed outer skin of the aircraft. In this case, the locking device can be actuated without tools, namely by lowering or raising the plate manually and thereby engaging or releasing the locking hook on or from its mating part via the mechanism.

In the locked state of the locking device, the plate is generally flush with the outer surface of the aircraft in order in this way to achieve surfaces on the aircraft which are as smooth as possible and do not cause aerodynamic problems. In the open state, however, the plate projects at a certain angle from the outer surface of the aircraft, thereby satisfying the relevant construction regulations for commercial aircraft, e.g. FAR 25.783 or CS 25.783, which require a clear, visually perceptible indication at least of some flaps or doors that are not fully locked.

However, it occasionally happens that locking devices are not correctly locked, e.g. after a maintenance measure has been carried out and before the aircraft is put into operation. This results in the risk that flaps or doors may open and break off due to the airflow, which may lead to endangerment of the aircraft and of its occupants but also of third parties on the ground.

There is a known practice of painting locking devices in conspicuous colors that differ from the color of the aircraft outer surface and are generally day-glow colors. One disadvantage of this solution, as recognized by the inventors, is then that day-glow colors require shortwave light in the UV or near-UV range to achieve their conspicuous signal effect. Often, these lighting conditions are not present, e.g. when preparing an aircraft in twilight or darkness. In the case of monochromatic apron lighting too, e.g. by means of gas discharge lamps, locking devices painted in day-glow colors are not particularly prominent.

Another disadvantage, as recognized by the inventors, with the use of day-glow colors is that red or orange hues are often used in the external painting of aircraft, e.g. of fixed antennas or drain masts, with the result that a certain habituation to this color occurs and they are no longer perceived as particularly noticeable.

The disadvantage of additional devices for improved recognition of unlocked locking devices consists in the technical effort for installation and maintenance and hence also in the costs and reliability of such devices as well as in the fact that, in many cases, they can be retrofitted only with difficulty, if at all, for technical or economic reasons.

### SUMMARY

An embodiment of the present invention provides a locking device, which can be embedded flush into a surface and is intended for locking flaps of an aircraft. The locking device includes a plate and a locking element, which is actuatable thereby. In a locked state of the locking device, the plate is flush with the surface and, in an open state, the plate projects from the surface. At least some faces of the locking device, which are situated on an inside with respect to the surface in the locked state and are visible only in the open state, are coated with photoluminescent material.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1. shows a first illustrative embodiment of a locking device according to the invention in the installed state;

FIG. 2 shows a detail illustration of the locking device from FIG. 1;

FIG. 3 shows a design variant of the locking device from FIG. 1 and FIG. 2;

FIG. 4 shows a schematic cross section through a first illustrative embodiment of the construction of the photoluminescent coating shown in FIG. 2 or FIG. 3; and

FIG. 5 shows a schematic cross section through a second illustrative embodiment of the construction of the photoluminescent coating shown in FIG. 2 or FIG. 3.

### DETAILED DESCRIPTION

Embodiments of the present invention provides a locking device for locking flaps with increased recognizability, as well as to provide methods for increasing the recognizability of existing locking devices.

The invention relates to a locking device, which can be embedded flush into a surface and is intended for locking flaps, in particular for aircraft. The locking device includes a plate and a locking element, which can be actuated thereby in the locked state of the locking device, the plate is flush with the surface and, in the open state, projects from the surface. At least some of the faces of the locking device, which are situated on the inside with respect to the surface in the locked state and are visible only in the open state, are coated with photoluminescent material.

The invention furthermore relates to a method for retrofitting a locking device, which can be embedded flush into a surface, comprising a plate and a locking element which can be actuated thereby. In the locked state of the locking device, the plate is flush with the surface and, in the open state, projects from the surface. At least some of the faces of the locking device, which are situated on the inside with respect to the surface in the locked state and are visible only in the open state, are coated with photoluminescent material.

The invention makes use of the insight of the present inventors that a coating with photoluminescent material at least of those faces that are visible in the open state of the locking device makes it possible to significantly enhance the recognizability of the open state of a locking device under various ambient conditions, especially in twilight and at night.

Photoluminescent coatings generally have a yellow, blue-green, or red natural color, which is easily recognizable in daylight. In this context, the natural color can be chosen in such a way that the contrast obtained with the color of the surface surrounding the locking device is as great as possible. In the case of a surface that is otherwise red or reddish, a photoluminescent coating with a yellow natural color can be chosen, for example, while, in the case of a substantially white surface, a coating with a red natural color can be chosen.

During twilight or darkness, the photoluminescent coating is likewise readily visible since it emits previously absorbed radiant energy as visible light in a certain light color and thus in practice afterglows. While, in twilight, the ambient light that is still available may be sufficient to activate the photoluminescent property of the coating, with the result that it begins to glow in its luminous color and is therefore easily recognizable. The invention makes use of the insight by the present inventors, particularly in respect of darkness, that locking devices used to secure flaps are often opened only for maintenance purposes. After the locking device has been opened and the corresponding flap has been opened, therefore, maintenance work is carried out on the elements, which are usually covered thereby, for which purpose in principle sufficient lighting is ensured. This lighting is usually sufficient to charge the photoluminescent coating, thus enabling it to afterglow, and thus, to be easily recognized even after the conclusion of the maintenance work and the associated removal of the lighting.

Because photoluminescent coatings generally emit the stored energy in the form of light at a different wavelength from the wavelength absorbed to charge the coating, it is possible-given—an appropriate choice of the photoluminescent material—to ensure that the coating is activated by apron lighting, which is monochromatic or at least does not emit the full spectrum of visible light—e.g. by means of sodium vapor lamps or LED lighting—and that light is emitted at a wavelength that may differ from the light of the apron lighting, thus ensuring that the photoluminescent coating is easily recognizable, even under such conditions.

It is possible for that outer side of the locking device which is flush with the surrounding surface and is visible in the closed state also to have a photoluminescent coating. In this case, the locking device is easily recognizable in various lighting situations, even in the closed state. In order to ensure good recognizability of the open state of the locking device in this case, it is preferred if the coating on the outer side of the locking device has a different natural color and/or luminous color from the coating on the faces that are visible only in the open state. By virtue of the difference in color, it is furthermore easy to recognize whether a locking device is open or closed.

The photoluminescent coating preferably has a multilayer construction comprising a reflective layer, a photoluminescent layer and a translucent, preferably transparent, top layer to protect against damage to the underlying layers.

The coating can be applied by sequential application of the individual layers to the faces of the locking device which are provided for this purpose. In this way, it is possible first of all to apply a reflective layer, then a photoluminescent layer and, finally, a translucent top layer. In this process, recourse may be had to conventional painting methods, such as dipping, brushing, rolling, pouring or spraying.

As an alternative, it is possible to pre-produce the coating as a multilayer coating element, which is then adhesively bonded onto the faces provided for this purpose. For this purpose, at least one of the layers of the coating element is embodied as a film, to which the other layers are applied, e.g. by painting methods or by integral connection to further layers embodied as films. In order to facilitate the attachment of a coating element of this kind to the closure element, the coating element can comprise an adhesive layer, thus enabling the coating element to be fixed to the closure element in a manner similar to a sticker.

It is preferred if the reflective layer has a reflectance of more than 75%, and/or the photoluminescent layer has a proportion by weight of luminescent pigments of 15% to 75%, preferably of 20% to 45% or 40% to 75%.

It is preferred if the thickness of the coating is less than 1 mm, preferably less than 0.75 mm, as a further preference between 0.15 mm and 0.5 mm. In the case of a correspondingly small thickness of the coating, said coating can often be applied to already existing locking devices without the need to modify the locking devices for this purpose.

The photoluminescence which, according to the invention, is envisaged for the coating can be achieved, for example, by means of zinc sulfide compounds and/or strontium aluminate compounds, which generally absorb radiation in the wavelength range of 250 nm to 500 nm and often emit light at a wavelength of from 450 nm to 650 nm.

For preference, the compound used for the photoluminescence and the proportion thereof by weight in the coating (or the photoluminescent layer) should be chosen so that the resulting luminance is 50 mcd/m\hat{ }2, preferably 100 mcd/m\hat{ }2 after 10 minutes of illumination in accordance with DIN 67510. It is particularly preferred if the luminance of the coating is 50 mcd/m\hat{ }2 after 10 minutes of charging at 100 lux, as a further preference the luminance of the coating being 75 mcd/m\hat{ }2 after 10 minutes of charging at 75 lux. A person skilled in the art will be capable of finding a coating to match these specifications with an acceptable amount of effort.

It is preferred if the coating is designed for a temperature range of −55° C. to +60° C. and/or a temperature gradient of 1° C./s.

For an explanation of the method according to the invention, reference may be made to the above statements.

The invention is now explained by way of example using preferred embodiments with reference to the attached drawings.

FIG. 1 illustrates a part of the outer surface 1 of an aircraft, on which a flap 2 that is attached on one side and is therefore pivotable forms part of the outer surface 1. The flap 2 can be selectively secured in the illustrated closed state by means of the locking device 10.

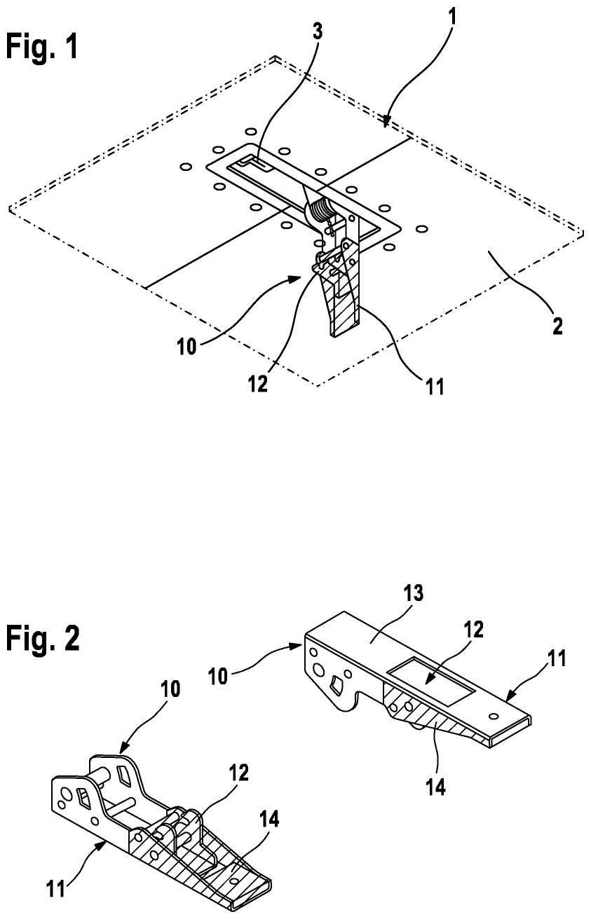

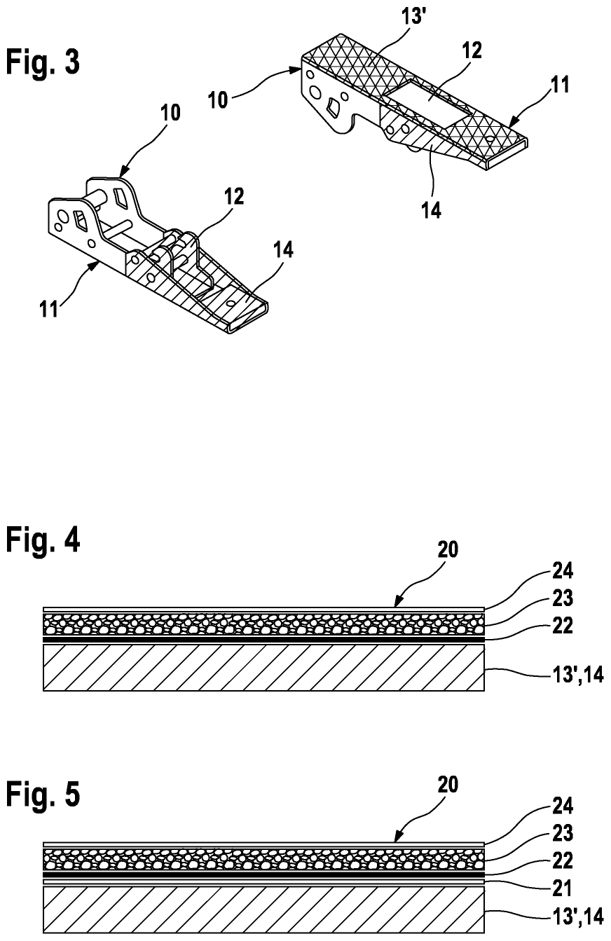

For this purpose, the locking device 10 has a pivotable plate 11, on which a locking element 12 designed as a hook is arranged. The plate 11 can be pivoted in such a way from the open state illustrated in FIG. 1, in which it projects from the outer surface 1, that it is flush with the outer surface 1. In this closed state, the locking element 12 engages in a mating part 3 on the fixed part of the outer surface 1 in order in this way to secure the flap 2 in the closed state. The locking element 12 is also accessible from the outside in the closed state through a window in the plate 11 (cf. FIGS. 2 and 3) and can thus be unlocked when required.

In FIG. 2, the locking device 10 from FIG. 1 is illustrated in isolation in two views.

The locking device 10 and, in particular, the plate 11 have painted surfaces 13, which are flush with the outer surface 1 in the closed state. These can be painted in the color of the outer surface 1 or in a day-glow color. Other faces 14 of the locking element 10—indicated by hatching in FIG. 2—which, although visible in the open state, illustrated in FIG. 1, of the locking element 10, are situated on the inside and are therefore not visible or are concealed by the faces 13 and the outer surface 1 in the locked state, are coated with a photoluminescent material. Both the natural color and the luminous color of the photoluminescent material are chosen in such a way that as great a contrast as possible is obtained relative to the color of the outer surface 1, both in daylight and at twilight or in darkness, in which the photoluminescent material phosphoresces.

FIG. 3 shows an alternative design variant to the locking device 10 shown in FIGS. 1 and 2 in an isolated illustration identical with FIG. 2.

In the design variant shown in FIG. 3, that face 13′ of the plate 11 which is flush with the outer surface 1 in the closed state is likewise coated with a photoluminescent material. In this case, both the natural color and the luminous color of the photoluminescent material on face 13′ are different from that of the photoluminescent material on the faces 14 situated on the inside in the locked state.

Because the flap 2 secured by the locking element 10 is only opened to reach aircraft components situated behind it or for maintenance purposes or the like, the locking element 10 is in principle opened only under adequate artificial lighting during darkness, and this is generally sufficient to charge the photoluminescent material on the faces 14, with the result that the faces 14 phosphoresce even after the discontinuation of the artificial lighting—e.g. because the maintenance work is finished. Thus, locking devices 10 which are not properly locked are easily recognizable, even in darkness.

In the case of lighting scenarios with a monochromatic light—e.g. apron lighting with gas discharge lamps—the photoluminescent material on the faces 14—and optionally also on face 13′—can emit light at a different wavelength from the monochromatic lighting, and therefore the locked state of a locking device 10 is easily recognizable.

Owing to the fact that the natural color chosen for the photoluminescent material on faces 14—and optionally also on face 13′—contrasts with the surrounding outer surface 1, the recognizability of the locked state of a locking device 10 in daylight is comparable to locking devices marked with day-glow colors.

FIG. 4 illustrates a first possible multilayer construction of the coating 20 with photoluminescent material on faces 13′ and/or 14 of the locking device 10, wherein the coating 20 shown in FIG. 4 is created by sequential application of the individual layers 22, 23, 24 to the respective faces 13′, 14.

As the lowest layer, that closest to face 13′, 14, the coating 20 comprises a reflective layer 22 with a reflectance of more than 75% and a layer thickness of 10 μm to 100 μm.

On this reflective layer 22 there is a photoluminescent layer 23 comprising 20% to 45% by weight of a photoluminescent strontium aluminate compound. The strontium aluminate compound is chosen in such a way that it has a luminance of 100 mcd/m\hat{ }2 after 10 minutes of illumination in accordance with DIN 67510 and furthermore is not damaged within a temperature range of from −55° C. to +60° C. and a temperature gradient of 1° C./s. The thickness of the photoluminescent layer is about 100 μm to 400 μm.

Finally, a transparent top layer 24, consisting of a paint based on polyurethane or acrylate for example, by means of which the photoluminescent layer 23 is protected from abrasion and other damage, is provided. Owing to the transparency of this layer 24, the photoluminescence of the underlying layer 23 is not impaired. The top layer 24 has a thickness of about 5 μm to 50 μm.

The individual layers 22, 23, 24 can be applied by any conventional painting method, e.g. dipping, brushing, rolling, pouring or spraying, wherein, in particular, retrospective application to locking elements 10 that are already in use is also possible. In this way, it is possible to retrofit already existing locking elements 10 in accordance with the invention.

An alternative multilayer construction of the coating 20 is illustrated in FIG. 5. In this illustrative embodiment, the coating 20 with all its layers 21-24 is configured as a coating element 20′ which is applied to a face 13′, 14 by means of a simple adhesive bonding step.

The lowest layer 21 of the coating element 20′ is an adhesive layer 21, by means of which the coating element 20′ can be stuck onto a face 13′, 14 easily in a manner comparable to a sticker. In this case, the adhesive layer 21 is configured as a film, thereby enabling the entire coating element 20′ to be handled as a film.

A reflective layer 22, a photoluminescent layer 23 and a top layer 24 are applied in a manner comparable to the design variant in FIG. 4 to the adhesive layer 21 configured as a film. The individual layers can be applied to the adhesive layer film 21 by screen printing, for example. For an explanation of the properties of the individual layers 22, 23, 24, reference may be made to the above statements relating to FIG. 4.

The thickness of the coating element 20′ comprising all the layers 21-24 is 300 μm to 800 μm. The configuration of the coating 20 as a coating element 20′ makes it possible to coat a locking device 10 even under ambient conditions which do not allow direct application, as explained in conjunction with FIG. 4.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A locking device which can be embedded flush into a surface and is intended for locking flaps of an aircraft, the locking device comprising a plate and a locking element, which is actuatable thereby,
wherein, in a locked state of the locking device, the plate is flush with the surface and, in an open state, the plate projects from the surface, and
wherein at least some faces of the locking device, which are situated on an inside with respect to the surface in the locked state and are visible only in the open state, are coated with photoluminescent material.

2: The locking device as claimed in claim 1, wherein an outer side of the locking device has a photoluminescent coating, wherein a natural color or a luminous color of the photoluminescent coating differs from that of the faces that are visible only in the open state of the locking device.

3: The locking device as claimed in claim 1, wherein the coating with the photoluminescent material has a multilayer construction comprising a reflective layer, a photoluminescent layer, and a translucent top layer.

4: The locking device as claimed in claim 3, wherein the coating is applied by a sequential application of the individual layers to at least one of the faces of the locking device.

5: The locking device as claimed in claim 3, wherein the coating is created by a multilayer coating element having at least one layer embodied as a film, which is adhesively bonded onto at least one of the faces.

6: The locking device as claimed in claim 5, wherein the coating element comprises an adhesive layer.

7: The locking device as claimed in claim 3, wherein the reflective layer has a reflectance of more than 75%, or the photoluminescent layer has a proportion by weight of luminescent pigments of 15% to 75%.

8: The locking device as claimed in claim 1, wherein a thickness of the coating is less than 1 mm.

9: The locking device as claimed in claim 1, wherein the coating comprises zinc sulfide compounds or strontium aluminate compounds.

10: The locking device as claimed in claim 1, wherein the coating has a luminance of at least 50 mcd/m\hat{ }2 after 10 minutes of illumination in accordance with DIN 67510 or a luminance of at least 75 mcd/m\hat{ }2 after 10 minutes of charging at 75 lux.

11: The locking device as claimed in claim 1, wherein the coating is configured for a temperature range of −55° C. to +60° C. or a temperature gradient of 1° C./s.

12: A method for retrofitting a locking device which can be embedded flush into a surface, the locking device comprising a plate and a locking element, which can be actuated thereby, wherein, in a locked state of the locking device, the plate is flush with the surface and, in an open state, the plate projects from the surface, the method comprising:
coating with photoluminescent material at least some of faces of the locking device that are situated on an inside with respect to the surface in the locked state and are visible only in the open state.

13: The method as claimed in claim 12, wherein the coating comprises a sequential application of individual layers to at least one of the faces of the locking device.

14: The method as claimed in claim 12, wherein the coating comprises adhesively bonding a pre-produced multilayer coating element onto at least one of the faces.

15. (canceled)

16: The locking device as claimed in claim 7, wherein the photoluminescent layer has the proportion by weight of the luminescent pigments of 20% to 45% or 40% to 75.

17: The locking device as claimed in claim 7, wherein the photoluminescent layer has the proportion by weight of the luminescent pigments of 40% to 75.

18: The locking device as claimed in claim 8, wherein a thickness of the coating is between 0.15 mm and 0.5 mm.

19: The locking device as claimed in claim 8, wherein a thickness of the coating is less than 0.75 mm.

20: The locking device as claimed in claim 10, wherein the coating has a luminance of at least 100 mcd/m\hat{ }2 after 10 minutes of illumination in accordance with DIN 67510 or a luminance of at least 75 mcd/m\hat{ }2 after 10 minutes of charging at 75 lux.
